(19) United States
(12) Patent Application Publication
(10) Pub. No.: US 2025/0097404 A1
(43) Pub. Date: Mar. 20, 2025

(54) Method and Apparatus Deriving Merge Candidate from Affine Coded Blocks for Video Coding

(71) Applicant: MEDIATEK INC., Hsinchu City (TW)

(72) Inventors: Tzu-Der CHUANG, Hsinchu City (TW); Ching-Yeh CHEN, Hsinchu City (TW)

(21) Appl. No.: 18/727,516

(22) PCT Filed: Jan. 6, 2023
(86) PCT No.: PCT/CN2023/070909

§ 371 Date: Jul. 9, 2024

Related U.S. Application Data
(60) Provisional application No. 63/299,530, filed on Jan. 14, 2022.

(51) Int. Cl. H04N 19/105; H04N 19/137; H04N 19/176

(52) U.S. Cl. CPC H04N 19/105; H04N 19/137; H04N 19/176

(57) ABSTRACT

Methods and apparatus of video coding are disclosed. According to this method, input data comprising pixel data for a current block to be encoded at an encoder side or encoded data of the current block to be decoded at a decoder side is received. When one or more reference blocks or sub-blocks of the current block are coded in an affine mode, the following coding process is applied: one or more derived MVs (Motion Vectors) are determined for the current block according to one or more affine models associated with said one or more reference blocks or sub-blocks; a merge list comprising at least one of said one or more derived MVs as one translational MV candidate is generated; and predictive encoding or decoding is applied to the input data using information comprising the merge list.

### CROSS REFERENCE TO RELATED APPLICATIONS

The present invention claims priority to U.S. Provisional Patent Application, Ser. No. 63/299,530, filed on Jan. 14, 2022. The U.S. Provisional Patent Application is hereby incorporated by reference in its entirety.

### FIELD OF THE INVENTION

The present invention relates to video coding using motion estimation and motion compensation. In particular, the present invention relates to deriving a translational MV (motion vector) from an affine-coded block using the affine model.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information.

Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Merge Mode

To increase the coding efficiency of motion vector (MV) coding in HEVC, HEVC has Skip and Merge modes. Skip and Merge modes obtains the motion information from spatially neighbouring blocks (spatial candidates) or a temporal co-located block (temporal candidate). When a PU is coded in Skip or Merge mode, no motion information is coded, instead, only the index of the selected candidate is coded. For Skip mode, the residual signal is forced to be zero and not coded. In HEVC, if a particular block is encoded as Skip or Merge, a candidate index is signalled to indicate which candidate among the candidate set is used for merging. Each merged PU reuses the MV, prediction direction, and reference picture index of the selected candidate.

For Merge mode in HM-4.0 of HEVC, as shown in FIG. 2, up to four spatial MV candidates are derived from A₀, A₁, B₀ and B₁, and one temporal MV candidate is derived from T_{BR} Or T_{CTR} (T_{BR} is used first, if T_{BR} is not available, T_{CTR} is used instead) for the current block 210. Note that if any of the four spatial MV candidates is not available, the position B₂ is then used to derive another MV candidate as a replacement. After the derivation process of the four spatial MV candidates and one temporal MV candidate, removing redundancy (pruning) is applied to remove redundant MV candidates. If after removing redundancy (pruning), the number of available MV candidates is smaller than five, three types of additional candidates are derived and added to the candidate set (candidate list). The encoder selects one final candidate within the candidate set for Skip or Merge modes based on the rate-distortion optimization (RDO) decision, and transmits the index to the decoder.

Hereafter, we will denote the Skip and Merge mode as “Merge mode”, that is, when we say “Merge mode” in the later paragraph, we mean both Skip and Merge mode.

### Affine Model

In contribution ITU-T13-SG16-C1016 submitted to ITU-VCEG (Lin, et al., “Affine transform prediction for next generation video coding”, ITU-U, Study Group 16, Question Q6/16, Contribution C1016, September 2015, Geneva, CH), a four-parameter affine prediction is disclosed, which includes the affine Merge mode. When an affine motion block is moving, the motion vector field of the block can be described by two control point motion vectors or four parameters as follows, where (vx, vy) represents the motion vector

$$\{ \begin{matrix}{x}^{′} = ax + by + e \\ {y}^{′} = - bx + ay + f \\ vx = x - {x}^{′} \\ vy = y - {y}^{′}\end{matrix} {⇒}^{Δ} \{ \begin{matrix}vx = ( 1 - a ) x - by - e \\ vy = ( 1 - a ) y + bx - f\end{matrix} \qquad ( 1 )$$

An example of the four-parameter affine model is shown in FIG. 3, where a corresponding reference block 320 for the current block 310 is located according to an affine model with two control-point motion vectors (i.e., v₀ and v₁). The transformed block is a rectangular block. The motion vector field of each point in this moving block can be described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 2 )$$

$$or$$

$$\{ \begin{matrix}{v}_{x} = \frac{( {v}_{1 x} - {v}_{0 x} )}{w} x - \frac{( {v}_{2 x} - {v}_{0 x} )}{h} y + {v}_{0 x} \\ {v}_{y} = \frac{( {v}_{1 y} - {v}_{0 y} )}{w} x + \frac{( {v}_{2 y} - {v}_{0 y} )}{h} y + {v}_{0 y}\end{matrix} \qquad ( 3 )$$

In the above equations, (v₀ₓ, v_{0y}) is the Control Point Motion Vector, CPMV (i.e., v₀) at the upper-left corner of the block, and (v₁ₓ, v_{1y}) is another control Point Motion Vector, CPMV (i.e., v₁) at the upper-right corner of the block. When the MVs of two control points are decoded, the MV of each 4×4 block of the block can be determined according to the above equation. In other words, the affine motion model for the block can be specified by the two motion vectors at the two control points. Furthermore, while the upper-left corner and the upper-right corner of the block are used as the two control points, other two control points may also be used. An example of motion vectors for a current block can be determined for each 4×4 sub-block based on the MVs of the two control points according to equation (2). Four variable can be defined as follow:

$$dHorX = ( {v}_{1 x} - {v}_{0 x} ) / w \to Δ Vx when shifting 1 sample in X - direction$$

$$dVerX = ( {v}_{1 y} - {v}_{0 y} ) / h \to Δ Vy when shifting 1 sample in X - direction$$

$$dHorY = ( {v}_{2 x} - {v}_{0 x} ) / w \to Δ Vx when shifting 1 sample in Y - direction$$

$$dVerY = ( {v}_{2 y} - {v}_{0 y} ) / h \to Δ Vy when shifting 1 sample in Y - direction$$

In ITU-T13-SG16-C-1016, an affine Merge mode is also proposed. If current block 410 is a Merge PU, the neighbouring five blocks (C₀, B₀, B₁, C₁, and A₀ blocks in FIG. 4) are checked whether one of them is affine inter mode or affine Merge mode. If yes, an affine_flag is signalled to indicate whether the current PU is an affine mode. When the current PU is applied in affine Merge mode, it gets the first block coded with an affine mode from the valid neighbour reconstructed blocks. The selection order for the candidate block is from left, above, above right, left bottom to above left (i.e., C₀→B₀→B₁→C₁→A₀) as shown in FIG. 4. The affine parameter of the first affine coded block is used to derive the v₀ and v₁ for the current PU.

In affine motion compensation (MC), the current block is divided into multiple 4×4 sub-blocks. For each sub-block, the center point (2, 2) is used to derive a MV by using equation (3) for this sub-block. For the MC of this current, each sub-block performs a 4×4 sub-block translational MC.

### BRIEF SUMMARY OF THE INVENTION

Methods and apparatus of video coding are disclosed. According to this method, input data for a current block to be encoded at an encoder side or encoded data of the current block to be decoded at a decoder side is received. When one or more reference blocks or sub-blocks of the current block are coded in an affine mode, the following coding process is applied: one or more derived MVs (Motion Vectors) are determined for the current block according to one or more affine models associated with said one or more reference blocks or sub-blocks; a merge list comprising at least one of said one or more derived MVs as one translational MV candidate is generated; and predictive encoding or decoding is applied to the input data using information comprising the merge list.

In one embodiment, said one or more derived MVs are determined at one or more locations comprising left-top corner, right-top corner, center, left-bottom corner, right-bottom corner, or a combination thereof of the current block according to said one or more affine models. In another embodiment, said one or more locations comprise one or more target locations inside the current block, outside the current block or both.

In one embodiment, said one or more reference blocks or sub-blocks of the current block correspond to one or more spatial neighbouring blocks or sub-blocks of the current block. In another embodiment, said one or more derived MVs are inserted into the merge list as one or more new MV candidates. For example, said at least one of said one or more derived MVs can be inserted into the merge list before or after a spatial MV candidate for a corresponding reference block or sub-block associated with said at least one of said one or more derived MVs. In another embodiment, a spatial MV candidate in the merge list for a corresponding reference block or sub-block associated with said at least one of said one or more derived MVs is replaced by said at least one of said one or more derived MVs.

In one embodiment, said at least one of said one or more derived MVs is inserted into the merge list after a spatial MV candidate, after a temporal MV candidate or after one MV category.

In one embodiment, only first N derived MVs of said one or more derived MVs are inserted into the merge list, wherein N is a positive integer.

In one embodiment, said one or more reference blocks or sub-blocks of the current block correspond to one or more non-adjacent affine coded blocks.

In one embodiment, said one or more reference blocks or sub-blocks of the current block corresponds to one or more affine coded blocks with CPMVs (control-point MVs) or model parameters stored in a history buffer.

In one embodiment, only part of said one or more derived MVs associated with part of said one or more reference blocks or subblocks of the current block are inserted into the merge list.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the spatial neighbouring blocks and temporal collocated block for Merge candidate derivation.

FIG. 3 illustrates an example of four-parameter affine model, where a current block a reference block is shown.

FIG. 4 illustrates an example of inherited affine candidate derivation, where the current block inherits the affine model of a neighbouring block by inheriting the control-point MVs of the neighbouring block as the control-point MVs of the current block.

FIG. 5 illustrates an example of deriving a motion vector from the control-point motion vectors of a spatial neighbouring block coded in the affine mode as a translational MV candidate of the merge list according to one embodiment of the present invention.

FIG. 6 illustrates an exemplary flowchart for a video coding system utilizing a derived MV, that is derived from an affine coded reference block or subblock, as a translational MV candidate in a merge list according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In regular Merge mode or translational MV Merge mode (which includes the conventional Merge mode, MMVD (Merge MVD (Motion Vector Difference)) Merge mode, GPM (Geometry Partition Mode) Merge mode), the spatial neighbouring sub-block (e.g. 4×4 block) MV or non-adjacent spatial sub-block MV are used to derive the MV/MVP (MV Prediction) candidates regardless whether the corresponding CU of the sub-block is coded in an affine mode or not. From the affine model described above, if a CU is coded in an affine mode, we can derive any MV of any sample/point in the current picture according to the equation (2) or (3). For example, in FIG. 5, a spatial neighbouring CU (i.e., block A₁) is coded in an affine mode with CPMVs V₀, V₁, and V₂ at locations (x₀, y₀), (x₁, y₁), and (x₂, y₂). We can derive an MV, V_{LT}, at (x_{LT}, y_{LT}) by using the following equation:

$$\{ \begin{matrix}{v}_{L T x} = \frac{( {v}_{1 x} - {v}_{0 x} )}{w} ( {x}_{L T} - {x}_{0} ) + \frac{( {v}_{2 x} - {v}_{0 x} )}{h} ( {y}_{LT} - {y}_{0} ) + {v}_{0 x} \\ {v}_{L T y} = \frac{( {v}_{1 y} - {v}_{0 y} )}{w} ( {x}_{C} - {x}_{0} ) + \frac{( {v}_{2 y} - {v}_{0 y} )}{h} ( {y}_{LT} - {y}_{0} ) + {v}_{0 y}\end{matrix} .$$

Also, we can derive the Vc bv:

$$\{ \begin{matrix}{v}_{Cx} = \frac{( {v}_{1 x} - {v}_{0 x} )}{w} ( {x}_{C} - {x}_{0} ) + \frac{( {v}_{2 x} - {v}_{0 x} )}{h} ( {y}_{C} - {y}_{0} ) + {v}_{0 x} \\ {v}_{Cy} = \frac{( {v}_{1 y} - {v}_{0 y} )}{w} ( {x}_{C} - {x}_{0} ) + \frac{( {v}_{2 y} - {v}_{0 y} )}{h} ( {y}_{C} - {y}_{0} ) + {v}_{0 y}\end{matrix}$$

Similarly, we can derive an MV for the bottom-right corner (x_{BR}, y_{BR}). In this invention, we propose that when deriving the translational MV candidate in regular Merge mode, translational MV Merge mode, AMVP mode, or any MV candidate list, if the reference sub-block or reference block is coded in an affine mode, we can use its affine model to derive a translational MV for the current block as the candidate MV instead of using the reference sub-block MV or reference block MV. For example, in FIG. 5, the neighbouring block A1 520 (also shown in FIG. 2) of the current block 510 is coded in an affine mode. In VVC, the sub-block MV V_{A1} is used as one of the MV candidate (i.e., a translational MV) in the merge mode. In this invention, instead of using the V_{A1}, we can derive one or more MVs at selected locations of the current block according to the affine model and use them as the MV candidate from block A1. For example, the selected locations can be left-top corner, right-top corner, center, left-bottom corner, right-bottom corner or a combination thereof of the current block and the corresponding derived MVs at these locations are {V_{LT}, V_{RT}, V_{C}, V_{LB}, and V_{RB}} respectively.

In another embodiment, not only the derived MVs at the corner and center locations (i.e., {V_{LT}, V_{RT}, V_{C}, V_{LB}, and VRB}), but also any MV inside the current block that is derived from the target affine model can be used. In another embodiment, not only the {V_{LT}, V_{RT}, V_{C}, V_{LB}, and V_{RB}}, but also any MV around the current block that is derived from the target affine model can be used. With reference to FIG. 5, V_{H}, MV of a subblock 530 outside the bottom right corner of the current block, is derived and used as one of MV candidates (i.e., a translational MV) in the merge mode.

In another embodiment, the derived translational MV from the affine model (as referred as a trans-aff MV in this disclosure) can be inserted before or after the V_{A1}. For example, in the candidate list derivation, the V_{A1} will not be replaced by the trans-aff MV. The trans-aff MV can be inserted as a new candidate in the candidate list. Taking FIG. 2 for example, the trans-aff MV is inserted before V_{A1} and the new order of the candidate list would be B₁, A_{1aff}, A₁, B₀, A₀, B₂. In another example, the trans-aff MV is inserted after V_{A1} and the new order of the candidate list would be B₁, A₁, Alaff, B₀, A₀, B₂. In another example, the trans-aff MV is inserted after the spatial neighbouring MV, or after the temporal MV, or after one of the MV categories. As is known for VVC, there are various categories of MV candidates such as spatial MV candidates, temporal MV candidates, affine-derived MV candidates, history based MV candidates, etc. In the example of inserting the trans-aff MV after one of the MV categories, the order of target reference block/sub-block can follow the block scan order of the VVC or HEVC Merge list or AMVP list. In one embodiment, only the first N trans-aff MVs derived from one category can be inserted, where N is a positive integer. In another embodiment, the trans-aff MV in only part of blocks can be inserted. In other words, not all derived MV candidates derived for one MV category are inserted into the merge list. For example, only the trans-aff MV of block B₁, A₁, B₀, and A₀ can be inserted.

While the example in FIG. 5 illustrates the case of deriving a translational MV for the current block based on a spatial neighbouring block A₁, the present invention is not limited to this particular spatial neighbour. Any other previously coded neighbouring block can be used to derive the translation MV as long as the neighbouring block is coded in an affine mode.

Furthermore, not only using a spatial neighbouring block coded in an affine mode for deriving a translation MV, the present invention may also other previously coded blocks in the affine mode for deriving a translation MV. In another embodiment, the non-adjacent affine coded block can also use the proposed method to derive one or more trans-aff MVs for the candidate list. In another embodiment, the affine CPMV/parameter stored in history buffer can also use the proposed method to derive one or more trans-aff MVs for the candidate list. The spatial neighbouring block coded in an affine block, the non-adjacent affine coded block and the block with the affine CPMV/parameter stored in history buffer are referred as a reference block or subblock in this disclosure.

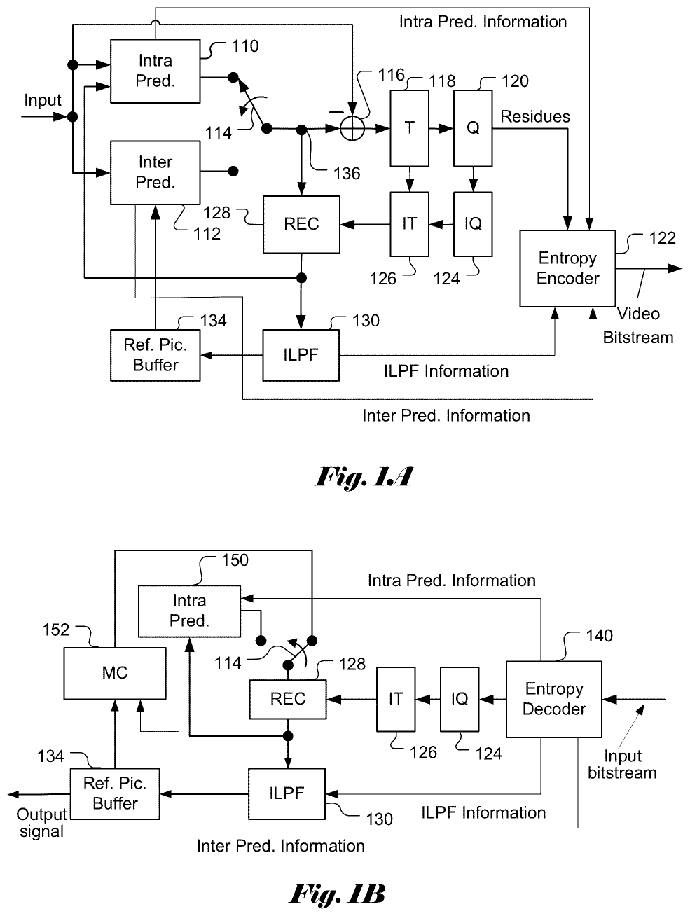

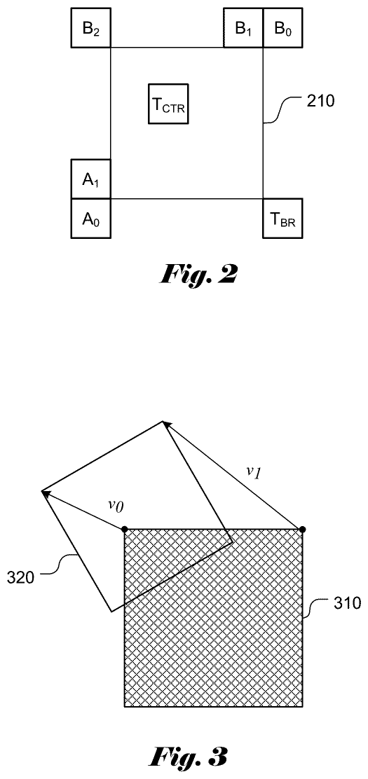

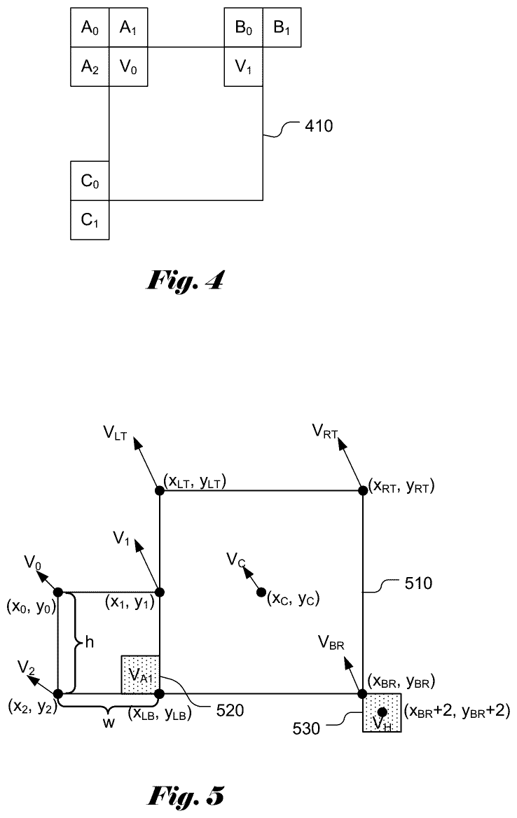

Any of the foregoing proposed methods can be implemented in encoders and/or decoders. For example, any of the proposed methods can be implemented in an affine/inter prediction module (e.g. Inter Pred. 112 in FIG. 1A or MC 152 in FIG. 1B) of an encoder and/or a decoder. Alternatively, any of the proposed methods can be implemented as a circuit coupled to affine/inter prediction module of the encoder and/or the decoder.

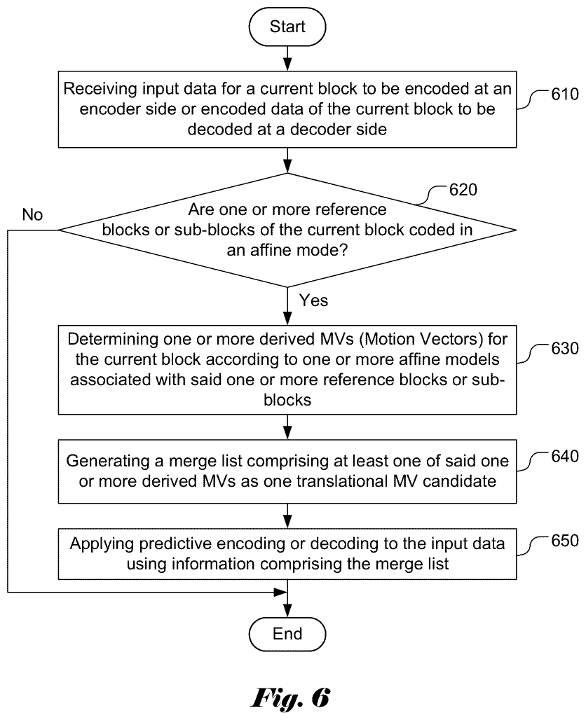

FIG. 6 illustrates an exemplary flowchart for a video coding system utilizing a derived MV, that is derived from an affine coded reference block or subblock, as a translational MV candidate in a merge list according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data comprising pixel data for a current block to be encoded at an encoder side or encoded data of the current block to be decoded at a decoder side is received in step 610. Whether one or more reference blocks or sub-blocks of the current block are coded in an affine mode is checked in step 620. If said one or more reference blocks or sub-blocks of the current block are coded in the affine mode, steps 630 to 650 are performed. Otherwise (i.e., said one or more reference blocks or sub-blocks of the current block are not coded in the affine mode), steps 630 to 650 are skipped. In step 630, one or more derived MVs (Motion Vectors) are determined for the current block according to one or more affine models associated with said one or more reference blocks or sub-blocks. In step 640, a merge list comprising at least one of said one or more derived MVs as one translational MV candidate is generated. In step 650, predictive encoding or decoding is applied to the input data using information comprising the merge list.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data for a current block to be encoded at an encoder side or encoded data of the current block to be decoded at a decoder side; and
when one or more reference blocks or sub-blocks of the current block are coded in an affine mode:
determining one or more derived MVs (Motion Vectors) for the current block according to one or more affine models associated with said one or more reference blocks or sub-blocks;
generating a merge list comprising at least one of said one or more derived MVs as one translational MV candidate; and
applying predictive encoding or decoding to the input data using information comprising the merge list.

2. The method of claim 1, wherein said one or more derived MVs are determined at one or more locations comprising left-top corner, right-top corner, center, left-bottom corner, right-bottom corner, or a combination thereof of the current block according to said one or more affine models.

3. The method of claim 2, wherein said one or more locations comprise one or more target locations inside the current block, outside the current block or both.

4. The method of claim 1, wherein said one or more reference blocks or sub-blocks of the current block correspond to one or more spatial neighbouring blocks or sub-blocks of the current block.

5. The method of claim 4, wherein said one or more derived MVs are inserted into the merge list as one or more new MV candidates.

6. The method of claim 5, wherein said at least one of said one or more derived MVs is inserted into the merge list before or after a spatial MV candidate for a corresponding reference block or sub-block associated with said at least one of said one or more derived MVs.

7. The method of claim 4, wherein a spatial MV candidate in the merge list for a corresponding reference block or sub-block associated with said at least one of said one or more derived MVs is replaced by said at least one of said one or more derived MVs.

8. The method of claim 1, wherein said at least one of said one or more derived MVs is inserted into the merge list after a spatial MV candidate, after a temporal MV candidate or after one MV category.

9. The method of claim 1, wherein only first N derived MVs of said one or more derived MVs are inserted into the merge list, wherein N is a positive integer.

10. The method of claim 1, wherein said one or more reference blocks or sub-blocks of the current block correspond to one or more non-adjacent affine coded blocks.

11. The method of claim 1, wherein said one or more reference blocks or sub-blocks of the current block corresponds to one or more affine coded blocks with CPMVs (control-point MVs) or model parameters stored in a history buffer.

12. The method of claim 1, wherein only part of said one or more derived MVs associated with part of said one or more reference blocks or subblocks of the current block are inserted into the merge list.

13. An apparatus of video coding, the apparatus comprising one or more electronics or processors arranged to:
receive input data for a current block to be encoded at an encoder side or encoded data for the current block to be decoded at a decoder side; and
when one or more reference blocks or sub-blocks of the current block are coded in an affine mode:
determine one or more derived MVs (Motion Vectors) for the current block according to one or more affine models associated with said one or more reference blocks or sub-blocks;
generate a merge list comprising at least one of said one or more derived MVs as one translational MV candidate; and
apply predictive encoding or decoding to the input data using information comprising the merge list.
